(19) United States
(12) Patent Application Publication
(10) Pub. No.: US 2025/0187013 A1
(43) Pub. Date: Jun. 12, 2025

(54) SYSTEMS AND METHODS FOR TESTING FOR INFECTIOUS DISEASE

(71) Applicants: Revvity Health Sciences, Inc., Waltham, MA (US); Revvity Cellular Technologies GmbH, Hamburg (DE)

(72) Inventors: Morey Richard Kraus, Harvard, MA (US); Jürgen Rolf Müller, Hamburg (DE); Richard Abraham Joseph, Stoughton, MA (US)

(21) Appl. No.: 18/976,921

(22) Filed: Dec. 11, 2024

Related U.S. Application Data
(60) Provisional application No. 63/609,013, filed on Dec. 12, 2023.

(51) Int. Cl. B01L 3/00

(52) U.S. Cl. CPC B01L 3/563; B01L 3/523; B01L 2200/16; B01L 2300/0654; B01L 2400/049

(57) ABSTRACT

Methods and apparatuses for detecting one or more target analytes in a sample, the apparatus including (i) a sample container for encapsulating a sample mixture comprising the sample and at least one lysis reagent; (ii) at least one vacutainer sealed at a negative pressure with a sealing element, and containing stabilized reagents corresponding to detecting at least one of the target analytes; and, (iii) at least one fluid communication channel oriented to enable an engageable fluid connection of the sample mixture from the sample container to one or more of the at least one vacutainers through the sealing element of each such fluidly-connected at least one vacutainer, wherein the establishment of the engageable fluid connection with the at least one vacutainer sealed at negative pressure causes at least some of the sample mixture from the sample container to be communicated to such fluidly-connected at least one vacutainer.

### CROSS-REFERENCE TO RELATED APPLICATION(S)

This application claims priority from U.S. Provisional Application No. 63/609,013, filed Dec. 12, 2023, the disclosure of which is hereby incorporated by reference in its entirety.

### BACKGROUND

People are, and will remain, vulnerable to the health threat of existing, evolving, and yet emergent infectious agents, unless appropriate countermeasures are established and maintained. For example, the recent convergence of Covid-19 (SARS-CoV-2) variants, the Flu (InfA/InfB) and Respiratory Syncytial Virus (RSV), demonstrated that cocirculation and coinfection patterns are dynamic. Relatively low vaccination rates, new infections, co-infections with multiple viruses, reinfections in populations with waning immunity, antigenic drift in the virus itself, antigenic shifts involving more than one virus, amongst other factors, allow for a very insecure and uncertain potential public health threat. There are significant technical and logistical gaps in the readiness to respond.

What is thus needed is a timely supply of rapid, cost effective, and accurate testing that fulfills the common users' needs and differentiates between known contagions. This may be coupled with targeted distribution, integrated surveillance, contact tracing, real-time digitally documented reporting, and modeling.

Existing technology does not meet this need, which cannot be fulfilled by centralized testing, mini-clinics or current over-the-counter tests. Each such testing modality is less than ideal for confronting a pandemic challenge from a ground zero event to a global outbreak. Turn-around-time, queuing, single agent detection, and poor sensitivity in the asymptomatic zone are some of the respective critical shortcomings of each of these approaches.

A device design that would enable the broad application of self-testing, tracking, tracing, and clinical surveillance for a variety of target infectious organisms, including microorganisms and viruses, would have significant utility in residential, commercial and clinical settings.

### SUMMARY

Disclosed is an apparatus for detecting the presence of one or more target analytes in a sample, the apparatus including (i) a sample container for encapsulating a sample mixture comprising the sample and at least one lysis reagent; (ii) at least one vacutainer sealed at a negative pressure with a sealing element, and containing stabilized reagents corresponding to detecting at least one of the target analytes; (iii) at least one engageable fluid communication channel oriented to enable a fluid connection of the sample mixture from the sample container to one or more of the at least one vacutainers through the sealing element of each such fluidly-connected at least one vacutainer, wherein the establishment of the fluid connection with the at least one vacutainer sealed at negative pressure causes at least some of the sample mixture from the sample container to be communicated to such fluidly-connected at least one vacutainer; and, (iv) a detection module in communication with the at least one vacutainer, and capable of detecting the presence of the target analytes. In embodiments, at least one target analyte is a control.

In embodiments, the stabilized reagents include at least one of: (i) stabilized amplification reagents; and. (ii) labeled probes associated with at least one of the target analytes; and, the detection module may be capable of detecting the labelled probes associated with the one or more target analytes. It may thus be understood that the vacutainer may encapsulate a “master mix” or reagents to allow for target analyte identification, amplification, and detection, based on methods known to those of ordinary skill. In the presently disclosed systems, the amount of sample mixture fluidly communicated from the sample container to each fluidly-connected at least one vacutainer is based on one or more of (i) a volume of each such fluidly-connected vacutainers, and/or (ii) a magnitude of the negative pressure in each such fluidly-connected vacutainer when the fluid connection is established. In some embodiments, the engageable fluid communication channel is a non-boring, hollow needle. In at least one such embodiment, the fluid connection is established manually by pressing the sample container onto the engageable fluid communication channel/needle, and the engageable fluid communication channel is disengaged, and hence the fluid connection disabled, by removing the manual pressure from the sample container when positioned on the needle. In embodiments, the engageable fluid communication channel comprises a first end for communicating with the sample container, and at least one second end shaped to communicate with one or more vacutainers. For example, the engageable fluid communication channel (e.g., needle) may include a first end for communicating with the sample container and a second, inverse-y-shaped end for communicating with two vacutainers. In embodiments, the engageable fluid communication channel may include a first end for communicating with the sample container and a second end having two or more subchannels or sub-ends for establishing a fluid connection with the negative pressure in two or more of the vacutainers, where the first end is in fluid communication with each of the two or more second ends and/or subchannels. The fluid communication channel may be arranged or configured to engage the first end of the fluid communication channel with the sample container prior to engaging the at least one second end of the fluid communication channel with the negative pressure in any one of the at least one vacutainer. The at least one second end of the fluid communication channel is arranged or configured such that each of the at least one second ends are sealed from atmospheric pressure or engaged with a vacutainer, when a first of such at least one second ends engages with a vacutainer.

Those of ordinary skill will understand that, when the engageable fluid communication channel includes two or more second ends to fluidically communicate with two or more vacutainers, if any one of the two or more second ends is connected to negative pressure in the two or more vacutainers, each of the other two or more second ends must either be connected to negative pressure in another of the two or more vacutainers, or be sealed (i.e., not at atmospheric pressure).

In certain embodiments, the stabilized amplification reagents are isothermal amplification reagents. For example, the stabilized amplification reagents may be for, e.g., loop-mediated isothermal amplification (LAMP), helicase-dependent amplification (HDA), rolling circle amplification (RCA), recombinase polymerase amplification (RPA), strand invasion based amplification (SIBA), multienzyme isothermal rapid amplification (MIRA). The stabilized amplification reagents may include the materials necessary for target specific amplification including but not limited to, enzymes, probes, labeled probes, intercalating dyes, and buffers.

In at least one embodiment, the sealing element is a membrane or septum, and in some embodiments, the sealing element is permeable. In some instances, the sealing element includes bromo-butyl rubber. For example, the sealing element may be in the form of a stopper that incudes or is made entirely of bromo-butyl rubber. Those of ordinary skill will understand that the sealing element can be of many different shapes and materials, and needs to be capable of maintaining the negative pressure in the vacutainer until at least such time that transfer of the sample mixture from the sample container to the vacutainer(s) is performed. For example, the sealing element may include a mechanical valve, diaphragm valves, ball valves, piston valves, and/or pinch valves.

It is thus understood that at least one of (i) the volume of a vacutainer, and/or (ii) the magnitude of the negative pressure in each vacutainer, is selected and/or determined and/or established based on an amount of the sample mixture desired to be fluidly communicated to such vacutainer when the fluid connection between the sample container and such vacutainer is established. In embodiments, the amount of sample mixture to be communicated to a fluidly-connected vacutainer may be at least 25 μl, at least 50 μl, at least 100 μl, at least 200 μl, or at least 300 μl.

In certain embodiments of the disclosed apparatus, detection module further includes a heating assembly, for example, for facilitating amplification of labeled target analytes in the sample mixture in the one or more vacutainers encapsulating a combination of sample mixture, stabilized amplification reagents, and labeled probes. In one example embodiment, the heating assembly may be configured to heat the vacutainer and/or its contents to a prescribed temperature to facilitate isothermal amplification. In one embodiment, the heating assembly may be configured to surround the vacutainer(s), and may be, e.g., an aluminum heat block. After amplification, the detection module may detect the number of amplified labeled antigen in each vacutainer. For example, the detection module may include at least one optical sensor for optically detecting fluorescent labels. In some embodiments, each vacutainer in the apparatus is configured with labelled probes that are different than the other vacutainers in the apparatus, such that each vacutainer in the apparatus may be associated with a different target analyte. In at least one embodiment, one optical detector may be associated with each vacutainer to detect labeled target analyte in such vacutainer, while in other embodiments, one optical detector may be associated with more than one vacutainer to detect labeled target analyte in more than one vacutainer.

In embodiments, the optical sensor may include an optical sensor system, where the optical sensor system includes at least one LED for illuminating one or more vacutainers, and at least one photodiode detector for optically detecting emissions from a vacutainer when a vacutainer is illuminated. In embodiments with multiple vacutainers and multiple target analytes, the labelled probes in each vacutainer positioned in the apparatus may be selected to emit, when illuminated, at different wavelengths, and optical detectors may be chosen to selectively detect at each of the different wavelengths. The labelled probes may include fluorescent dyes.

The detection module may include a microcontroller, and a graphical user interface. The microcontroller may be configured with programmable instructions to communicate user instructions to the graphical user interface, to allow the user to use the apparatus to detect the target analytes. In some embodiments, the microcontroller comprises programmable instructions for communicating to a remote device such as a telephone, via an app, or for example, via an email or text.

Also disclosed are methods for using the apparatus. Accordingly, disclosed are methods for detecting at least one target analyte in a fluid sample. In one embodiment, the methods comprise: (i) acquiring the fluid sample; (ii) combining the fluid sample in a sample container with at least one lysis reagent to create a sample mixture; (iii) providing at least one vacutainer, each vacutainer sealed at a negative pressure with a sealing element, and containing stabilized reagents corresponding to detecting at least one of the target analytes; (iv) engaging a fluid communication channel to create a fluid connection between the sample container and the at least one vacutainer through the sealing element of each fluidly-connected at least one vacutainer, wherein engagement of the fluid communication channel causes at least some of the sample mixture from the sample container to be communicated to such fluidly-connected at least one vacutainer; and, (v) determining the presence or absence of the at least one target analyte in the at least one vacutainer.

The lysis reagent may be lyophilized and/or may be included within a sub-container within a given vacutainer.

The disclosed methods include engaging the first end of the fluid communication channel with the sample container prior to engaging the at least one second end of the fluid communication channel with the negative pressure in any one of the at least one vacutainer. The methods include providing a fluid communication channel arranged or configured to engage the first end of the fluid communication channel with the sample container prior to engaging the at least one second end of the fluid communication channel with the negative pressure in any one of the at least one vacutainer. In embodiments, the methods include providing a fluid communication channel in which each of the at least one second ends are sealed from atmospheric pressure or engaged with a vacutainer, when a first of such at least one second ends engages with a vacutainer.

In some embodiments, the methods include disengaging at least the first or the second end(s) of the fluid communication channel prior to determining the presence or absence of the at least one target analyte.

In certain embodiments, the determining includes providing an optical detection system to detect fluorescently labelled target analytes.

In embodiments, the stabilized reagents include (a master mix of) reagents capable of identifying, amplifying, and facilitating and/or allowing for detecting the target analytes. Accordingly, the stabilized reagents may include amplification reagents (e.g., probes) and fluorescently labelled probes, and the methods include loading amplification reagents and fluorescently labelled probes into at least one vacutainer, prior to sealing the at least one vacutainer at negative pressure.

In some embodiments, the methods include determining, selecting, and/or establishing at least one of (i) a volume of a vacutainer, and/or (ii) a magnitude or an amount of negative pressure to store in each vacutainer, to allow for distribution of the sample mixture amongst the fluidly-connected vacutainers, prior to sealing such vacutainers with the determined magnitude or amount of negative pressure with a sealing element. The sealing element may be a permeable sealing element, and/or a self-healing, permeable sealing element.

The methods also include, in determining the presence or absence of the target analytes, heating the vacutainer sample mixture (which includes the stabilized reagents for identifying, amplifying, and detecting the target analytes) in the vacutainers to cause a reaction between the sample mixture and the stabilized reagents. In some embodiments, the reaction includes amplifying the target analytes, and in some of such embodiments, the reaction includes LAMP. The target analytes may be a target nucleic acid. In certain embodiments, detecting the presence or absence of the target analytes may not begin until after heating the vacutainer.

The disclosed methods may include determining at least one detection threshold for each of the at least one vacutainer that encapsulates sample mixture and reagents and is heated, as provided herein. In an embodiment where multiple target analytes are to be detected in a single vacutainer, determining the presence or absence of the target analytes includes determining at least one detection threshold for each vacutainer. In one embodiment, determining at least one detection threshold include determining a detection threshold for each target analyte in each vacutainer.

In some embodiments, determining at least one detection threshold includes performing an automated determination of the at least one detection threshold. For example, performing an automated determination may include performing measurements on the vacutainer prior to amplifying the target analytes to a detectable level, and determining the at least one detection threshold based on the performed measurements. The methods may also include determining the at least one detection threshold based on at least one statistical measure that is further based on the performed measurements. For example, the at least one statistical measure may be a combination of a mean, a median, and/or a standard deviation, derived from and/or based on the performed measurements.

In embodiments where optical detection may be used, performing measurements may include performing optical measurements of the at least one vacutainer. For example, if multiple target analytes are present in a single vacutainer and each target analyte is fluorescently labelled for emission at different wavelength bands, determining a detection threshold may include performing optical measurements at one or more of the different wavelength bands and determining a detection threshold at one or more of the different wavelength bands.

Performing measurements to determine a detection threshold may include performing optical measurements prior to amplifying the target analytes to a detectable level/amount, determining at least one of a mean and standard deviation based on the performed optical measurements, and determining the at least one detection threshold based on at least one of the mean and standard deviation. As provided herein, performing measurements occur at one or more different wavelength bands associated with the (fluorescent labels of the) target analytes.

The methods may also include reporting the results as soon as a detected amount of a target analyte exceeds a detection threshold, and stopping the detection of a given target analyte once the detected amount of a target analyte exceeds a detection threshold. In some embodiments, the methods include stopping the detection of all target analytes when detected amounts of all target analytes exceed one or more detection thresholds associated with the target analytes. In embodiments, the methods include determining the absence of a target analyte(s) if the detected amount of such target analyte(s) does not exceed a detection threshold(s) within at least 5 minutes, at least 10 minutes, at least 15 minutes, at least 20 minutes, at least 25 minutes, or at least 30 minutes, from the heating of the one or more vacutainers.

In some methods, engaging the fluid communication channel includes manually depressing the sample container to engage and/or make contact with the fluid communication channel to cause a fluidic connection between the sample container and the at least one vacutainer. In certain embodiments, the methods include providing instructions to a user via a graphical user interface. Providing instructions may include providing instructions to a user to take a sample, insert a sample into a sample container, manually press the sample container to engage the fluid communication channel, release the sample container, and/or update the user on time to results. Providing instructions may include providing results to a user. Providing results to a user may include displaying results related to the presence or absence of the target analytes on a graphical user interface, transmitting results to an app, transmitting results to an email, and/or communicating results to a networked device, where such network may be wired or wireless, secure or insecure.

One of ordinary skill will thus understand that the present disclosure includes methods, systems, and apparatus for performing a homogeneous assay to detect target analytes from a fluid sample that is suspected to include such target analytes.

Other objects and advantages will become apparent hereinafter in view of the specification and drawings.

### BRIEF DESCRIPTION OF THE DRAWINGS

FIG. 1 is a perspective view of the disclosed methods, apparatus, and systems according to some embodiments.

FIG. 2 is a cross sectional view of the cartridge and sample container of FIG. 1.

FIGS. 3A-3D are cross sectional views of different internal cartridge and sample containers according to some embodiments.

FIGS. 4A-4E illustrates various example vacutainer and fluid communication channel configurations according to some embodiments.

FIG. 5 is a perspective view of an engagement of a disposable cartridge containing vacutainers of FIGS. 1 and 2.

FIGS. 6A-6C are schematic view of a hub with a microcontroller that is configured to communicate to additional devices and/or networks according to some embodiments.

FIG. 7 illustrates various aspects of a sample container engaged in a disposable cartridge, further engaged in a reusable hub according to some embodiments.

FIG. 8 is a cross sectional view of an example of a detection unit for a single vacutainer according to some embodiments.

FIG. 9 is a perspective view of an example sample container engaged with a fluid communication channel that is, e.g., a hollow needle according to some embodiments.

FIG. 10A is a schematic diagram of exemplary circuitry that may be included on a printed circuit board (“PCB”) in a configuration of the disclosed methods, systems, and apparatus that allow for multiplexed detection of up to eight different target analytes according to some embodiments.

FIG. 10B is a graph of the wavelength (nm) and the spectral responsitivity of a device according to some embodiments.

### DESCRIPTION

To provide an overall understanding, certain illustrative embodiments will now be described; however, it will be understood by one of ordinary skill in the art that the systems and methods described herein can be adapted and modified to provide systems and methods for other suitable applications and that other additions and modifications can be made without departing from the scope of the systems and methods described herein.

Unless otherwise specified, the illustrated embodiments can be understood as providing exemplary features of varying detail of certain embodiments, and therefore, unless otherwise specified, features, components, modules, and/or aspects of the illustrations can be otherwise combined, separated, interchanged, and/or rearranged without departing from the disclosed systems or methods. Additionally, the shapes and sizes of components are also exemplary and unless otherwise specified, can be altered without affecting the scope of the disclosed and exemplary systems or methods of the present disclosure.

The disclosed methods and systems relate generally to sample testing for infectious disease, and more particularly to sample testing for infectious disease that can be performed by an individual that provided the sample, within minutes of providing the sample (“home test(s)”). Home tests can also be performed with the assistance of another person (e.g., guardian, parent, spouse, clinician, etc.) and are not restricted to use in residential settings. Existing technology employs motors, pumps, presses, capillaries, valves and other means to move fluids through a micro-laboratory workflow. Motors and pumps are expensive, have wide standards of error, provide poor mixing, and entrap problematic air slugs in the fluid path. Nucleic acid tests are thus traditionally limited due to the complexity of workflows required to capture, lyse, amplify and detect infectious diseases. As used herein, a vacutainer is a sample container. A vacutainer is typically sterile and formed of glass or plastic. A vacutainer may have a stopper, such as a rubber stopper, to create a vacuum seal inside of the tube and may include a needle for drawing a sample, such as blood.

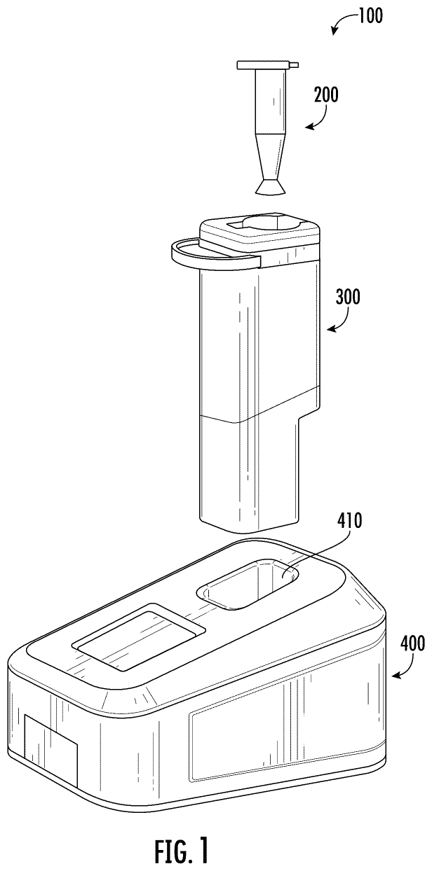

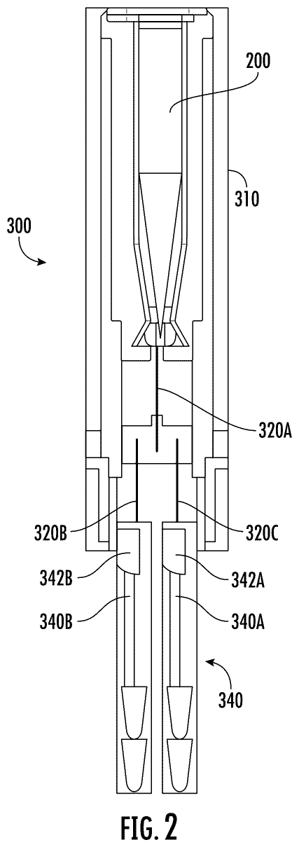

FIG. 1 is a perspective view of the disclosed methods, apparatus, and systems. FIG. 2 is is a cross sectional view of the cartridge and sample container of FIG. 1. The apparatus 100 includes a sample container, which is depicted as a sample container or tube 200, and as shown, illustrates a sample mixture encapsulated therein. In the illustration of FIG. 1, the sample is a fluid sample. The apparatus 100 includes a disposable cartridge 300 for receiving the sample container, and the disposable cartridge 300 also includes vacutainers 340A, 340B sealed at a negative pressure with stabilized reagents contained in the vacutainers 340A, 340B. The illustrated reusable hub 400 includes an opening 410, which receives the disposable cartridge 300 and includes a detection module, including for example, a heating system and an optical detection system. However, it should be understood that the detection module may be incorporated into any suitable element or provided separately. For example, the detection module may be provided in the hub 400 or the disposable cartridge 300.

FIG. 2 illustrates an internal view of a disposable cartridge such as on according to that shown in FIG. 1, with a sample container 200 engaged in the disposable cartridge 300. The illustrated engageable fluid communication channel 320A, 320B, 320C shown in FIG. 2 is a non-boring hollow needle with the ability to transfer sample mixture from the sample container to two different vacutainers 340A, 340B as shown in FIG. 2 as being placed in parallel to each other, although such arrangement of vacutainers 340A, 340B is for illustration and not limitation. As shown, the needle is oriented in a “sample splitter” orientation, with one first end and two second ends, to transfer at least some of the sample mixture from the sample container to each of the two illustrated vacutainers.

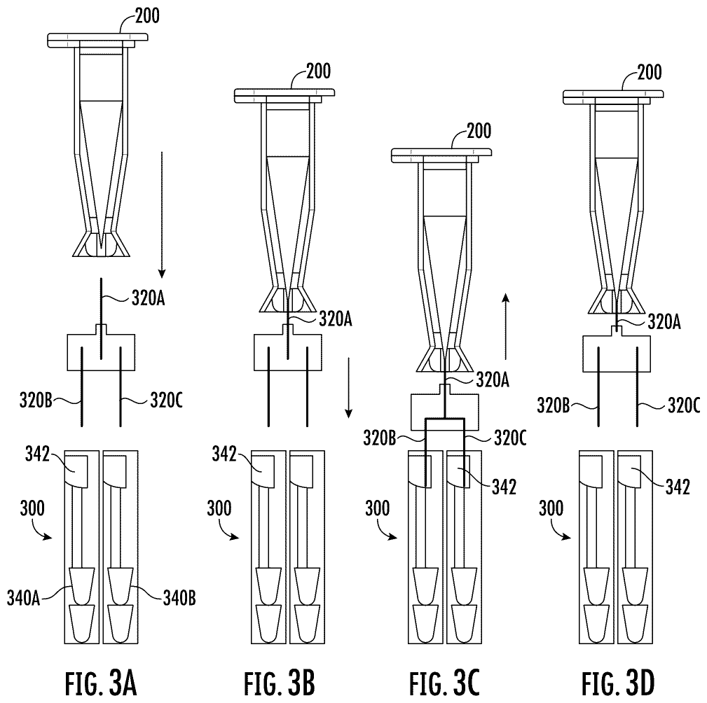

FIGS. 3A-3D are cross sectional views of different internal cartridge and sample containers according to some embodiments. FIGS. 3A-3D show various phases of the fluid connection enabled by the “sample splitter” needle configuration. As shown in FIGS. 3A-3D, as the sample container 200 is pressed into the disposable cartridge 300 (FIG. 3C), a first end of the needles pierces the bottom of the sample container, and the two prongs or parts of the second end of the needles pierce the sealing element of each vacutainer. As disclosed, at least one of (i) the volume of each (fluidly-connected) vacutainer 340A, 340B; and/or, (ii) the magnitude of the negative pressure in each (fluidly-connected) vacutainer 340A, 340B, is relative to the amount of sample mixture that is transferred from the sample container to each such fluidly-connected vacutainer 340A, 340B. The sample mixture may mix with stabilized reagents that were populated in the vacutainers 340A, 340B prior to being sealed with negative pressure. As shown in FIG. 3, a sealing element 342 is a stopper that includes bromo-butyl rubber; however, it should be understood that any suitable sealing element may be used.

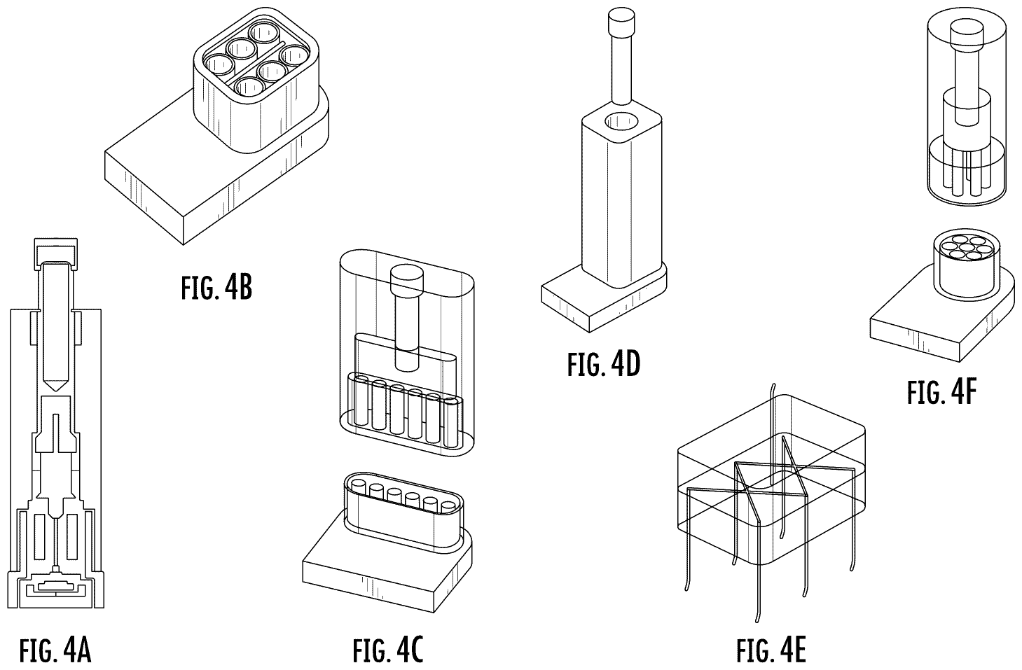

FIGS. 4A-4E illustrates various example vacutainer and fluid communication channel configurations according to some embodiments. FIGS. 4A-4E illustrate vacutainer/fluid connection channels that allow for detection of multiple target analytes from a single sample mixture to multiple vacutainers (“sample splitter” configurations), where each vacutainer may be configured with stabilized reagents to allow for the detection of different target analytes. As shown, there may be one or more second ends of the fluid communication channel that may take the form of have multiple segments, subchannels, forks, prongs, etc., that are each fluidically coupled to the first end of the communication channel that is capable of engaging with the sample container. Accordingly, any suitable number of vacutainers and fluid connection channels may be used.

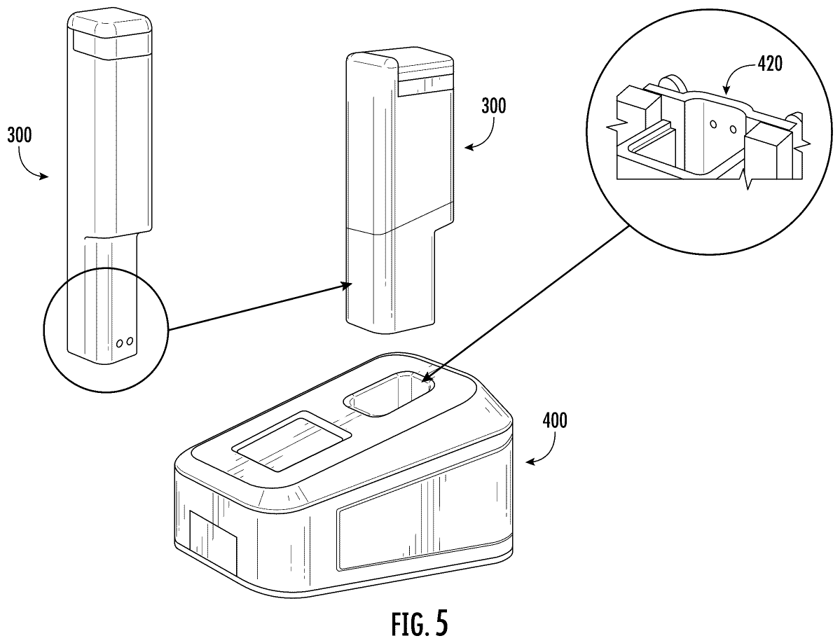

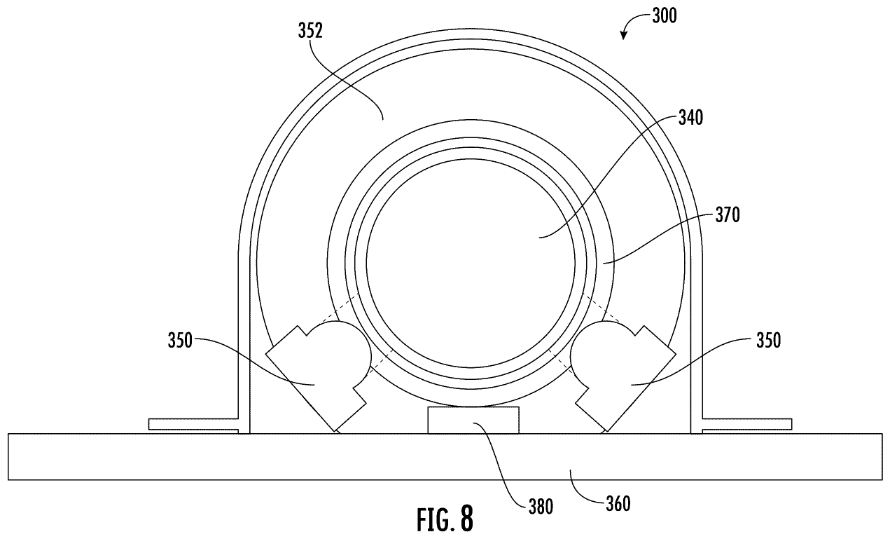

FIG. 5 is a perspective view of the engagement of a disposable cartridge 300 containing vacutainers of FIGS. 1 and 2. The reusable hub 400 includes a detection module that further includes a heater, for example, as shown in FIG. 8 below. As shown in FIG. 5, the hub 400 includes a tension loaded docking mechanism 420 for engaging the disposable cartridge 300 and vacutainers with the reusable hub 400.

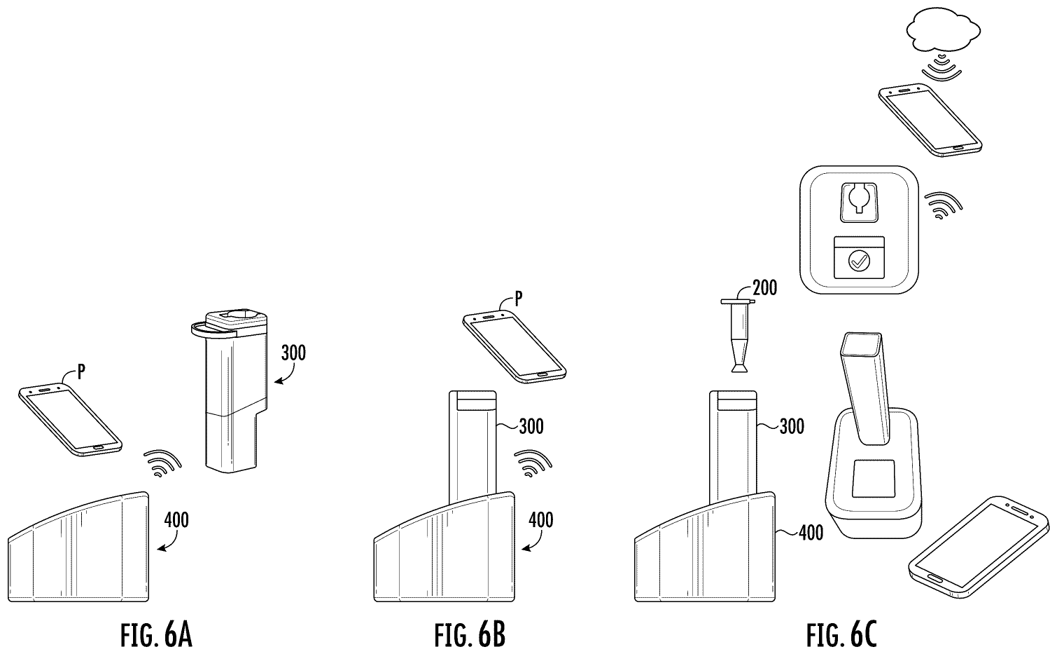

FIGS. 6A-6C are schematic view of a hub with a microcontroller that is configured to communicate to additional devices and/or networks according to some embodiments. As illustrated in FIGS. 6A-6C, a reusable hub 400 is equipped with a microcontroller to allow for communication of results via a wired and/or wireless network connection, including for example, an intranet, the internet, an app, or another wired or wireless network, which can communicate results from the hub 400 to another computer, such as the phone P.

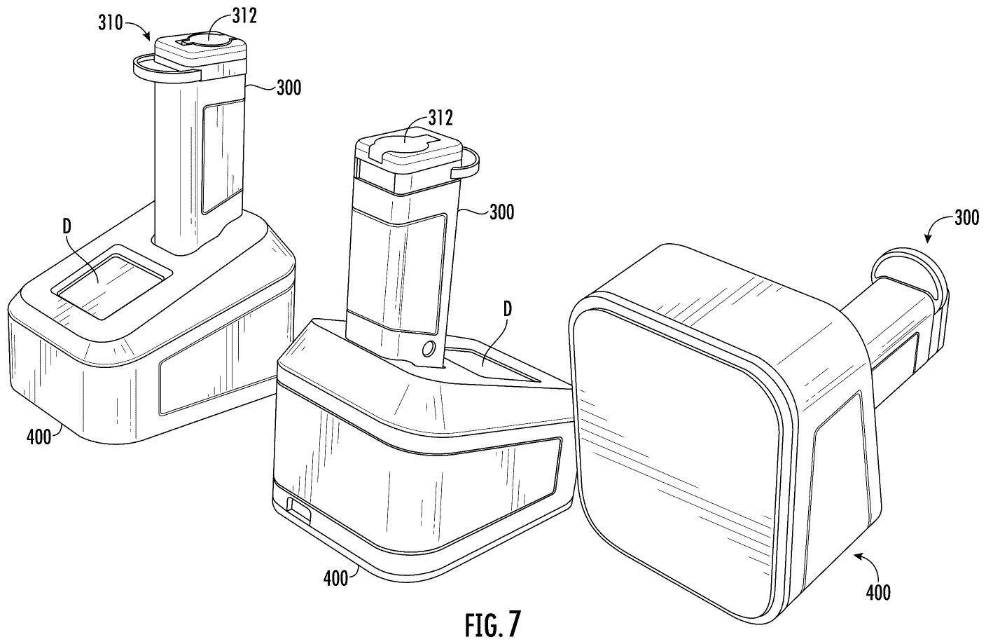

FIG. 7 illustrates various aspects of a sample container 200 engaged in a disposable cartridge 300, which is further engaged in a reusable hub 400. The hub 400 further includes a user interface or display D for communicating results or other operations with a user.

FIG. 8 is a cross sectional view of an example of a detection module for a single vacutainer 340 according to some embodiments. As shown, a printed circuit board (“PCB”) 360 may include a microprocessor with instructions for causing the microprocessor to control a heating unit as disclosed herein, control an optical detection system as disclosed, and communicate detection results of the one or more target analytes, as shown, for example, in FIG. 6. As shown, a heating element or wire 370 may be positioned around the vacutainer 340 and LEDs 350 may be positioned to illuminate the sample in the vacutainer 340. An insulating layer 352 may be around the vacutainer. An optical detector 380 may be positioned to detect optical signals from the vacutainer 340. Although the optical detector 380 may be positioned on a side of the vacutainer 340, it should be understood that any suitable location, such as below the vacutainer 340, may be used.

Although a heating wire 370 is shown in FIG. 8, the heating assembly, unit or element may be configured to surround the vacutainer(s), and may be, e.g., an aluminum heat block in the form of a tube, although the disclosed apparatus, systems, and methods shall not be limited to a particular shape and/or type of heating element, and it can be understood that the heating element can be of many forms and types as long as it is capable of heating the contents of the vacutainer to cause a reaction between the sample mixture and the reagent master mix encapsulated in the vacutainer. In one version of the illustrated embodiment, the heating assembly includes a heat block that is heated using a spring-loaded heat transfer docking plate in the reusable hub, which in some embodiments, optionally includes a flexible heater element, and a thermocouple. Closed-loop temperature control is implemented using the microprocessor, which may be connected to or otherwise communicate with the heater and thermocouple. The microprocessor may similarly have instructions for communicating users instructions to a GUI that may be, e.g., on the reusable hub, an app, or another wired or wireless connected device (e.g., smart phone). Also shown in FIG. 8 are two LEDs configured to enable illumination of the vacutainer. The LEDs may be controlled by the microcontroller.

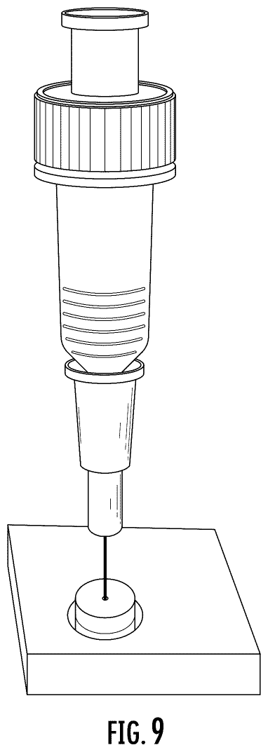

FIG. 9 is a perspective view of an example sample container engaged with a fluid communication channel that is, e.g., a hollow needle.

The disclosed systems and methods include an apparatus and method for detecting and/or determining the presence or absence of infectious diseases, that provides high sensitivity, and a substantially automated workflow. The present disclosure thus relies on stored negative pressure to move a sample mixture that includes a fluid sample. This approach reduces or eliminates significant cost, moves the fluid without confounding air bubbles, and vigorously mixes the reagent and sample using in part, at least one vacutainer that stores negative pressure and stabilized (e.g., lyophilized) reagents (e.g., amplification reagents, fluorescently labelled probes), to move a sample mixture from a sample vessel, into the vacutainer/reaction chamber upon establishing or engaging a fluid connection between the vacutainer and sample vessel. The vacutainer/reaction chamber can then be heated and the contents illuminated to provide a signal to at least one optical detector.

The present disclosure includes a test device that includes at least one closed bottom vacutainer/reaction chamber of known void volume. The vacutainer/reaction chamber may be made of any suitable material, but in one embodiment, is glass. The vacutainer may also include plastic or another suitable material for being sealed with negative pressure and otherwise being heated and/or optically observed as provided herein.

The vacutainer/reaction chambers described herein may be configured to be under negative pressure, and in certain embodiments, encapsulates lyophilized reagents prior to being sealed with a sealing element. The sealing element may take one of many various forms as long as it seals the vacutainer/reaction chamber. In some embodiments, it is self-healing.

Sealing elements (e.g., sealing element 342 in FIG. 3) that are self-healing can provide a convenient way to establish the negative pressure in the vacutainers during manufacturing. For example, vacutainers can be loaded with stabilized reagents at environmental pressure and sealed with the self-healing sealing element. The sealing element can then be pierced with, e.g., a needle, to extract pressure and create a desired amount of negative pressure within the vacutainer before withdrawing, e.g., the needle. The self-healing aspect of the sealing element in such embodiments can allow for the maintenance of substantially the same negative pressure for an extended period of time; however, other manufacturing processes may be used that do not require a self-healing sealing element, and such other processes may include loading the vacutainer with the stabilized reagents and applying a seal in an (micro) environment that is maintained at a desired negative pressure.

It can be understood that a self-healing sealing element may also ensure that no reagents, sample mixture, amplicons, and/or any combinations thereof, can exit the vacutainer during use of the disclosed systems, apparatus, and methods, for example, after the fluidic communication channel has been engaged, and optionally, disengaged; however, the disclosed systems, methods, and apparatus do not require that the sealing element be air-tight or otherwise completely or perfectly seal a vacutainer, particularly after the engagement of the fluid communication channel.

The stabilized reagents may include isothermal amplification enzymes and oligonucleotides sequences, and may include fluorescently labelled probes. In some embodiments, the reagents may be included as part of the sealing element. The sealing element may be a membrane, and may include, for example, bromo-butyl rubber, but other materials (e.g., neoprene) may be used to seal the negative pressure in the vacutainer, and such materials may be based on, for example, the fluid communication channel to ensure that the fluid communication channel can permeate the sealing material. Those of ordinary skill will understand that appropriate sealing elements may include polymers or elastomers, metals, ceramics, and/or cementitious materials.

The disclosed apparatus and methods include the acquiring of a liquid sample of known volume, e.g., saliva, of an amount of at least 10 μl, at least 50 μl, at least 100 μl, at least 250 μl, at least 500 μl, and up to 1000 μl, that is combined in a sample vessel with an aqueous media such as a lysis buffer to create a sample mixture. Those of ordinary skill will understand that the lysis buffer, which may be lyophilized, may be in an amount equal to, e.g., one to four times the sample volume. The sample may include other fluid samples containing target analytes for detection, and may include nasal secretions/swab, urine, blood, blood components (e.g., serum), vaginal or penile secretions, etc. The sample vessel may be maintained at atmospheric pressure. The disclosed methods and apparatus are intended to detect at least one target analyte in the sample through processing the sample mixture as disclosed herein. It will thus be understood that references herein to a target analyte include a target nucleic acid.

The present disclosure also includes a fluid communication channel oriented to enable a fluid connection between the sample mixture in the sample container and one or more of the vacutainers/reaction chambers, where in some embodiments (e.g., permeable sealing elements), such connection is established through the sealing element of each such fluidly-connected vacutainer/reaction chamber. In such embodiments, it can thus be understood that the fluid communication channel must be oriented or arranged to permeate the sealing element of the vacutainers. The fluid communication channel may also be arranged to permeate or otherwise pierce the sample container to make contact with the sample mixture, to allow for fluid communication from the sample container to the vacutainer(s) as described herein. Upon establishment of the fluid connection, at least one of the volume of each fluidly-connected vacutainer and/or the negative pressure in such vacutainer(s), causes at least some of the sample mixture from the sample container to be communicated to such fluidly-connected vacutainer(s).

In one embodiment, the engageable fluid communication channel may be engaged with manual pressure. In one embodiment where the engageable fluid communication channel is a non-boring, hollow needle, the needle may be in a fixed position and a user of the apparatus and method may engage the communication channel by manually depressing the sample container onto a first end of the needle. Such manual force may similarly, and in some embodiments, simultaneously, cause the second end(s) of the needle to permeate the sealing elements of one or more vacutainers, thereby causing the sample mixture to flow from the sample container through the needle to the vacutainer/reaction chambers, where such sample mixture flow is based on and/or in relation to the negative pressure in the vacutainer(s). Release of the manual pressure may cause the engageable fluid communication channel to disengage from the first end and the second end(s). In some embodiments, disengagement of the fluid communication channel may not be required to detect the target analytes.

Those of ordinary skill will understand that in embodiments of the disclosed methods and systems that employ a sample-splitter configuration, e.g., the fluid communication channel has a first end and two or more second ends, the sample container must engage with the first end before any of the two or more second ends engage with the negative pressure of the two or more vacutainers; and, when one of the second ends engage with the negative pressure of the two or more vacutainers, the other of the two or more ends must be sealed (i.e., not at atmospheric pressure) or be in communication with the negative pressure in one of the other two or more vacutainers.

In one embodiment, a spring or other mechanism providing a resistive force can be used to ensure that the sample container engages with the first end of the engageable fluid communication channel, before any of the second ends of the fluid channel engage with the negative pressure in any of the two or more vacutainers. The disclosed methods thus include engaging the first end of the fluid communication channel with the sample container prior to engaging the at least one second end of the fluid communication channel with the negative pressure in any one of the at least one vacutainer. In the illustrated embodiments, the sealing of the two or more second ends of the fluid communication channel is accomplished by providing sealing elements in the vacutainers of a sufficient length (e.g., butyl rubber plug or stopper) such that any minor differences in the second ends/splitter of the fluid communication channel are compensated by sealing such ends with the sufficiently long sealing element, prior to engaging with the negative pressure in the two or more vacutainers. By selecting a sealing element with sufficient length to sealing the contents of the vacutainer(s) and the second end(s) of the engageable fluid communication channel, sufficient sample mixture volume can be delivered, via negative pressure, to each of the vacutainers to allow for a reaction and detection of the presence or absence of target analytes (or a control), as provided herein. Accordingly, in some of the illustrated embodiments, applying a first amount of manual pressure may allow for engaging the sample container with the first end of the fluid communication channel, and thereafter, applying a second amount of pressure may allow for engaging the second end(s) of the fluid communication channel with negative pressure in the vacutainer(s).

In some embodiments, a user may be informed via a graphical user interface (GUI) that may be resident on the apparatus or a mobile device (e.g., app or other wired or wireless connection to the apparatus) when to begin applying the manual force, and when to end application of the manual force, to engage and disengage, respectively, the engageable fluid communication channel.

Introduction of the sample mixture into the vacutainer(s)/reaction chamber(s) may be detected via a sensor, which may be, for example, an optical sensor that is capable of monitoring the presence of liquid inside the vacutainer(s)/chamber(s). Some embodiments may use an electro-mechanical or optical sensor that monitors the presence of the engageable fluid communication channel (e.g., needle) with the valve and/or the vacutainer(s)/reaction chamber(s).

In embodiments, the disclosed apparatus includes a detection module, and the vacutainer(s)/reaction chamber(s) may be pre-installed in the detection module and positioned to allow for engagement with the second end of the engageable fluid communication channel. In some instances, the detection module includes a heating module/assembly and the vacutainer(s) may be in thermal communication with the heating module/assembly. The heating assembly may include a heat spreader made of aluminum or another material with sufficient heat conduction to the vacutainers to allow for reactions between the sample mixture and stabilized reagents (e.g., probes and labelled probes), in accordance with the disclosed methods and systems. The stabilized reagents may include, for example, BST polymerase (16-32 units), 6-10 LAMP probes per target ranging in concentration from 0.2 uM to 2.0 uM, labeled probes ranging from 0.8 uM to 2 uM, probe quenchers ranging from 0.8 to 2 uM, etc., and the concentration thereof may vary depending on whether a single-plex or multi-plex reaction is occurring in a given vacutainer. In some instances, the stabilized reagents may include, for example, BST polymeras (16-32 units), 6-10 LAMP probes per target ranging in concentration from 0.1 uM to 20 uM, labeled probes ranging from 0.4 uM to 2 uM, probe quenchers ranging from 0.4 to 2 uM, etc., and the concentration thereof may vary depending on whether a single-plex or multi-plex reaction is occurring in a given vacutainer. In one embodiment, the heat spreader may be surrounded by, e.g., an electrically powered resistive heater. In some embodiments, the vacutainer(s)/reaction chamber(s) may be pushed into the heating module/assembly by the same motion that engages the fluid connection channel (e.g., needle) into the vacutainer(s).

The heating assembly may also include a temperature sensor arranged with the heat spreader in a closed-loop configuration to regulate the temperature of the heat spreader and/or vacutainer(s) at a target temperature, or one of multiple selectable target temperatures. In embodiments, a microcontroller and/or analog control loop is provided to control the temperature feedback loop. Electrical power may be provided by a main power adapter or a battery. The battery may include an alkaline battery, for example, and may include a rechargeable battery. Those of ordinary skill will understand that in an embodiment including a microcontroller, the microcontroller will include instructions for establishing and regulating the heating assembly.

In an embodiment, when a sensor (e.g., fluid sensor, optical sensor) detects the introduction of sample the sample mixture into the vacutainer(s)/reaction chamber(s), the heating assembly may be initiated to establish the vacutainer(s) at a pre-selected temperature suitable for isothermal amplification of nucleic acids. In other embodiments, the heating assembly may be initiated/turned on to establish the vacutainer(s) to a temperature suitable for isothermal amplification of nucleic acids for as long as the apparatus is powered. In some embodiments, the heating assembly may be initiated to establish the vacutainer(s) to a pre-heat temperature, and switched to a temperature suitable for isothermal amplification of nucleic acids when sample introduction to the vacutainer/(s) reaction chamber(s) is detected.

As provided herein, when a sample mixture is introduced to the vacutainer(s)/reaction chamber(s) (e.g., via an engageable fluid communication channel), the sample mixture combines or mixes with the stabilized (e.g., lyophilized) reagents in the vacutainer(s)/reaction chamber(s). Depending on the embodiment, the heating assembly may then be maintained or established at an operating temperature suitable for isothermal amplification of nucleic acids for at least 30 minutes, or such other time sufficient to develop a reliable positive or negative result based on the abundance/presence or absence of, e.g., fluorescence, related to amplified nucleic acid sequences in the reaction chamber(s)/vacutainer(s).

The abundance/presence or absence of amplified nucleic acid sequences in the reaction chamber(s)/vacutainer(s) can be detected in multiple different ways that are known to those of ordinary skill, and the present systems and methods are not limited to such detection techniques. By way of illustration and not limitation, e.g., fluorescent markers can be detected (e.g., in real time) inside the vacutainer(s)/reaction chamber(s) by providing suitable illuminators, spectral filters, and detectors arranged appropriately in relation to the reaction chamber. The heating assembly may provide transparent openings for one or multiple light source(s) and detector(s). For example, light emitting diodes (“LEDs”) may be used as light sources and photodiodes as detectors. An example multi-spectral detector may include the AS734x detector by AMS OSRAM. The fluorescent markers may be provided in the reagent mix that is pre-loaded in the vacutainer(s)/reaction chamber such that the reagents are present in the vacutainer(s)/reaction chamber(s) in a substantially constant concentration throughout the isothermal amplification process. The fluorescent markers may be designed in one of various ways known in the art to alter or change their fluorescent emission level based on whether the markers are (directly or indirectly) bound to a specific nucleic acid sequence. For example, intercalating dyes or dye/quencher pairs conjugated to specific complementary nucleic acid sequences may be used. As soon as an abundance of the target analyte/nucleic acid(s) is detected to determine the presence thereof of such target analyte, the amplification and detection can be stopped and a positive result can be communicated. In embodiments, an abundance of the target nucleic acid to equate to presence of the target analyte(s) in a given vacutainer may be determined in an automated manner by performing measurements on the given vacutainer to obtain a “baseline” or “control” level. The performing of such measurements may be done prior to any substantial amplification of the target analytes in the vacutainer. For example, these measurements may be performed before or after introduction of the sample mixture to the vacutainers. If the measurements are made after introduction of the sample mixture to the vacutainers, then the measurements may be performed prior to heating the vacutainer and/or prior to heating the vacutainer for a time that would be known to one of ordinary skill in the art to cause detectable amplification of the target analytes.

The measurements may be performed multiple times for each vacutainer. For example, measurements may be performed at different emission wavelengths associated with (e.g., fluorescent labels/probes associated with) different target analytes in a given vacutainer. Accordingly, there may be more than one detection threshold determined for each vacutainer. For example, in an embodiment in which there are multiple target analytes to be detected in a vacutainer, multiple detection thresholds may be determined based on measurements performed on that vacutainer. In some embodiments, a single detection threshold may be used even if multiple target analytes are to be detected.

From the performed measurements, at least one statistical measure may be obtained or determined. For example, a mean, median, and/or standard deviation may be determined from the performed measurements. The one or more detection thresholds may be determined using a combination of the one or more statistical measures.

In an example embodiment using an optical detection system, measurements of fluorescence emissions may be performed on a vacutainer prior to detectable amplification of target analytes. In such example, statistical measures such as a mean and/or median fluorescence intensity in each vacutainer, at each wavelength of interest, and corresponding standard deviations, may be computed from the (e.g., optical) measurements taken prior to detectable amplification of the target analytes. A detection (“abundance”) threshold to indicate presence of the target analyte(s) (e.g., at the various applicable emission wavelengths, e.g., at various wavelengths within a range of the applicable emission wavelengths) may then be determined based on the statistical measures, e.g., the mean value plus a multiple of the standard deviation. Once a detection level is reached, a result can be determined, provided only one target analyte is in a given vacutainer. Accordingly, in embodiments, the present methods and systems are designed to provide notification of a positive result as early as possible/detection is determined. As provided herein, such result may be communicated to a GUI that is resident on the apparatus and/or another remote device (e.g., via an app, email, etc.).

Those of ordinary skill can thus understand that the disclosed methods and systems may have embodiments of multiplexed tests in which multiple target nucleic acids (or target analytes) may be detected. It can be understood that, at minimum, multiplexing may be performed in the form of the sample and a control to allow for verification of system performance via the control analyte. As is known, a control nucleic acid sequence (e.g., Actin) may be used in a multiplexed manner with the sample to confirm that the sample was correctly taken, introduced, and that the amplification and other reactions were properly performed.

In a multiplexing embodiment using fluorescent markers, different types of fluorescent markers that are excited at different wavelengths and have different emission wavelengths, may be provided in the same vacutainer/reaction chamber, where each type of fluorescent marker is conjugated to a different (amplified) target analyte-specific nucleic acid sequence. In some embodiments, these different fluorescent markers may be individually quantified by alternating illumination at the corresponding different fluorescence/emission wavelengths, and detecting fluorescence at the respective different emission wavelengths (e.g., optical detection). Emission and detection wavelengths may be in the visible range (e.g., 450 nm to 700 nm) in some embodiments that employ optical detection.

In one example embodiment, fluorescence detection may be achieved using LEDs with a full spectral bandwidth of 20 to 50 nm. An out-of-band suppression on the order of 10-2 may be used for light sources without additional spectral filtering. Photodiode detectors may be used with suitable spectral filters to define the emission band. One embodiment may employ an integrated multi-band detector (Osram AS7341) that includes filters with a full spectral bandwidth of 30 to 60 nm and an out-of-band suppression on the order of 10-2. In such embodiments, dye concentrations of 1 μM can be detected. With more careful correction for background signals, dye concentrations of 0.1 μM may be detected. Accordingly, sensitivity is limited by the background signal from LED light which reaches the detector via scattering from the sample and/or reflections from the vacutainer/reaction chamber, and which is not otherwise substantially suppressed by the spectral filters. Those of ordinary skill will thus understand that if detection of lower dye concentrations is desired, narrower optical filters with higher out-of-band suppression can be employed in the excitation and/or emission paths.

In some embodiments, nucleic acids can be labelled and detected after the amplification time via one of many lateral flow assays known to a person of ordinary skill. In such embodiments, a sealed negative pressure detection chamber may be provided to a test site and fluidically connected to a vacutainer/reaction chamber using a second engageable fluid communication channel. After the sample mixture is introduced to the vacutainer/reaction chamber and mixed with the lyophilized reagents for a pre-determined amplification time at an operating temperature suitable for isothermal amplification of nucleic acids, the second engageable fluid communication channel may be engaged to transfer the amplified mixture to a lateral flow strip. In some embodiments, the lateral flow strip provides optical labels and one or more binding regions for target analytes, as known in the art. After a pre-defined incubation time, the lateral flow strip is read using any one or more of several detection techniques know to those of ordinary skill, including but not limited to visual, photographic, image analysis, or photosensors.

Those of ordinary skill will also understand that a lateral flow assay can achieve multiplexing of different target analyte-specific nucleic acid sequences with downstream lateral flow detection by configuring the lateral flow strip with different target analyte-specific binding regions corresponding to the different target analyte-specific nucleic acid sequences, as known in the art.

In some embodiments, multiplexing of the disclosed systems and methods can be achieved by distributing a single sample across multiple vacutainers/reaction chambers upon introduction into the test device. In such embodiments, the engageable fluid communication channel may be in the configuration of a fluidic splitter (e.g., an inverse-Y or other multi-pronged fluidic channel) to allow connection from one sample container to two or more vacutainers/reaction chambers, each at negative pressure, but each pre-filled with different reagent mixes. In another embodiment, a single vacutainer/reaction chamber may be pre-filled and/or pre-populated with multiple different reagent mixes for detection more than one target analyte. In yet other embodiments, one vacutainer may be pre-filled with a reagent mix to detect one target analyte, and another vacutainer may be pre-filled to detect two or more target analytes. Those of ordinary skill will understand that many combinations of the foregoing are possible. In any of such embodiments, any suitable detection technique may be used on the individual or collective resulting amplified nucleic acid sequences in the vacutainers/reaction chambers.

Those of ordinary skill will thus understand that the disclosed methods and systems could be used, for example, to determine whether a sample contains one or more target analytes related to respiratory viruses, such as, e.g., InfA, InfB, SARS-CoV-2, RSV, while including a human control (Actin, RNaseP). In one example embodiment, reagents related to these target analytes can be preloaded into three vacutainers, with each vacutainer including reagents for two target analytes, and two different colors associated with each target analyte in a given vacutainer. As a further example, InfA and InfB could be in different vacutainers. In such an embodiment, each vacutainer of the same or similar volume could be initialized with the same negative pressure such that when the fluidic connection is made via the engageable fluid communication in a three-way sample splitter configuration, the sample mixture in would be divided substantially equally into thirds amongst the three vacutainers. The human control can serve to demonstrate that an adequate amount of sample mixture was added to each vacutainer, particularly in instances where no target analytes are detected.

In yet another embodiment, target analytes may include other respiratory viruses including HPIV, HPIV, HRV, ADV, HMPV, HBOV and AIV H5N1. In yet another embodiment infectious agents including TB, Ebola, Strep, MRSA, Monkeypox and others may be the target analytes.

The disclosed methods and systems thus allow for a modular yet integrated system with disposable components. For example, the sample container and a cartridge containing the vacutainers may be disposable. Cartridges may be loaded with vacutainers having different reagent mixes for detecting different target analytes. In some embodiments, a reusable hub may include a microcontroller, heating assembly, heater control system, and detection (e.g., optical, lateral flow) system (and optional heat spreader). The cartridges containing the vacutainers may be engaged with the reusable hub to allow for detection and communication of target analyte detection.

The disclosed methods and systems thus allow for and contemplate automated notification of results, for example, using network communications to various devices as illustrated in FIGS. 6A-6C. For example, in embodiments with optical detection, the detection system may be integrated to an intranet and/or the internet and configurable to be able to transmit and/or convey test results via electronic messaging (e.g., text, email, SMS, etc.). Such transmitted results may be direct or via remote servers, and may be of various formats, including QR codes and other formats for information known in the art.

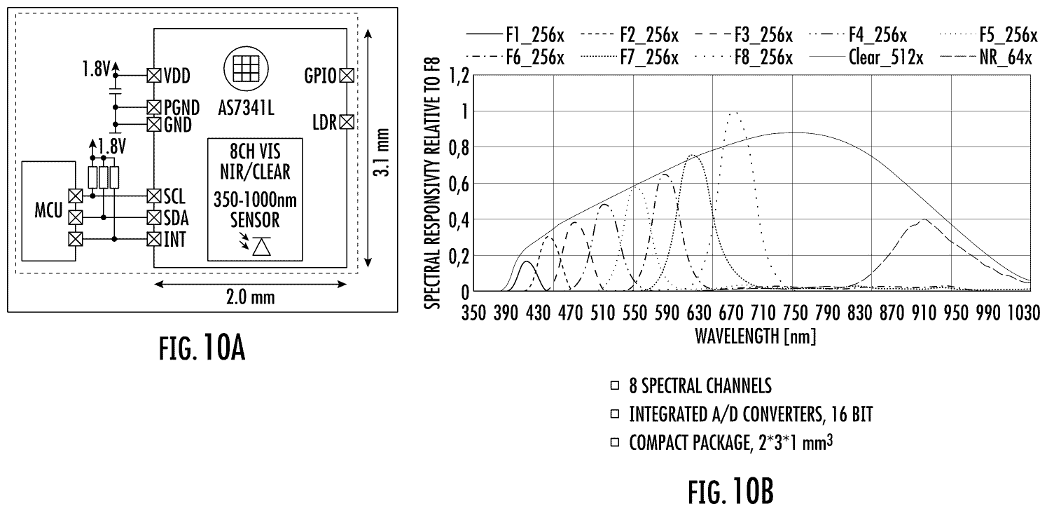

FIG. 10A is a schematic diagram of exemplary circuitry that may be included on a printed circuit board (“PCB”) in a configuration of the disclosed methods, systems, and apparatus that allow for multiplexed detection of up to eight different target analytes.

FIG. 10B is a graph of the wavelength (nm) and the spectral responsitivity of a device according to some embodiments. FIG. 10B illustrates the measured spectral responsitivity normalized to a particular channel, which indicates different emission wavelength windows that the optical sensor detects.

What has thus been described is are methods and systems for detecting one or more target analytes in a sample, the apparatus including (i) a sample container for encapsulating a sample mixture comprising the sample and at least one lysis reagent; (ii) at least one vacutainer sealed at a negative pressure with a sealing element, and containing stabilized reagents corresponding to detecting at least one of the target analytes; and, (iii) at least one engageable fluid communication channel oriented to enable a fluid connection of the sample mixture from the sample container to one or more of the at least one vacutainers through the sealing element of each such fluidly-connected at least one vacutainer, wherein the establishment of the fluid connection with the at least one vacutainer sealed at negative pressure causes at least some of the sample mixture from the sample container to be communicated to such fluidly-connected at least one vacutainer.

The methods and systems described herein are not limited to a particular hardware or software configuration, and may find applicability in many computing or processing environments. The methods and systems can be implemented in hardware or software, or a combination of hardware and software. The methods and systems can be implemented in one or more computer programs, where a computer program can be understood to include one or more processor executable instructions. The computer program(s) can execute on one or more programmable processors, and can be stored on one or more storage medium readable by the processor (including volatile and non-volatile memory and/or storage elements), one or more input devices, and/or one or more output devices. The processor thus can access one or more input devices to obtain input data, and can access one or more output devices to communicate output data. The input and/or output devices can include one or more of the following: Random Access Memory (RAM), Redundant Array of Independent Disks (RAID), floppy drive, CD, DVD, magnetic disk, internal hard drive, external hard drive, memory stick, or other storage device capable of being accessed by a processor as provided herein, where such aforementioned examples are not exhaustive, and are for illustration and not limitation.

The computer program(s) can be implemented using one or more high level procedural or object-oriented programming languages to communicate with a computer system; however, the program(s) can be implemented in assembly or machine language, if desired. The language can be compiled or interpreted.

As provided herein, the processor(s) can thus be embedded in one or more devices that can be operated independently or together in a networked environment, where the network can include, for example, a Local Area Network (LAN), wide area network (WAN), and/or can include an intranet and/or the internet and/or another network. The network(s) can be wired or wireless or a combination thereof and can use one or more communications protocols to facilitate communications between the different processors. The processors can be configured for distributed processing and can utilize, in some embodiments, a client-server model as needed. Accordingly, the methods and systems can utilize multiple processors and/or processor devices, and the processor instructions can be divided amongst such single or multiple processor/devices.

The device(s) or computer systems that integrate with the processor(s) can include, for example, a personal computer(s), workstation (e.g., Sun, HP), personal digital assistant (PDA), handheld device such as cellular telephone, laptop, handheld, or another device capable of being integrated with a processor(s) that can operate as provided herein. Accordingly, the devices provided herein are not exhaustive and are provided for illustration and not limitation.

References to “a microprocessor” and “a processor”, or “the microprocessor” and “the processor,” can be understood to include one or more microprocessors that can communicate in a stand-alone and/or a distributed environment(s), and can thus can be configured to communicate via wired or wireless communications with other processors, where such one or more processor can be configured to operate on one or more processor-controlled devices that can be similar or different devices. Use of such “microprocessor” or “processor” terminology can thus also be understood to include a central processing unit, an arithmetic logic unit, an application-specific integrated circuit (IC), and/or a task engine, with such examples provided for illustration and not limitation.

Furthermore, references to memory, unless otherwise specified, can include one or more processor-readable and accessible memory elements and/or components that can be internal to the processor-controlled device, external to the processor-controlled device, and/or can be accessed via a wired or wireless network using a variety of communications protocols, and unless otherwise specified, can be arranged to include a combination of external and internal memory devices, where such memory can be contiguous and/or partitioned based on the application. Accordingly, references to a database can be understood to include one or more memory associations, where such references can include commercially available database products (e.g., SQL, Informix, Oracle) and also proprietary databases, and may also include other structures for associating memory such as links, queues, graphs, trees, with such structures provided for illustration and not limitation.

References to a network, unless provided otherwise, can include one or more intranets and/or the internet. References herein to microprocessor instructions or microprocessor-executable instructions, in accordance with the above, can be understood to include programmable hardware.

Unless otherwise stated, use of the word “substantially” can be construed to include a precise relationship, condition, arrangement, orientation, and/or other characteristic, and deviations thereof as understood by one of ordinary skill in the art, to the extent that such deviations do not materially affect the disclosed methods and systems.

Throughout the entirety of the present disclosure, use of the articles “a” or “an” to modify a noun can be understood to be used for convenience and to include one, or more than one of the modified noun, unless otherwise specifically stated.

The use of “include” or “includes” shall be understood to mean comprise or comprises, and shall not be limited to such included components, parts, elements, actions, etc.

Elements, components, modules, and/or parts thereof that are described and/or otherwise portrayed through the figures to communicate with, be associated with, and/or be based on, something else, can be understood to so communicate, be associated with, and or be based on in a direct and/or indirect manner, unless otherwise stipulated herein.

Although the methods and systems have been described relative to a specific embodiment thereof, they are not so limited. Many modifications and variations may become apparent in light of the above teachings.

Many additional changes in the details, materials, and arrangement of parts, herein described and illustrated, can be made by those skilled in the art. Accordingly, it will be understood that the following claims are not to be limited to the embodiments disclosed herein, can include practices otherwise than specifically described, and are to be interpreted as broadly as allowed under the law.

1. An apparatus for detecting the presence of one or more target analytes in a sample, the apparatus comprising:
(i) a sample container for encapsulating a sample mixture comprising the sample and at least one lysis reagent;
(ii) at least one vacutainer sealed at a negative pressure with a sealing element, and containing stabilized reagents corresponding to detecting at least one of the target analytes;
(iii) at least one engageable fluid communication channel oriented to enable a fluid connection of the sample mixture from the sample container to one or more of the at least one vacutainers through the sealing element of each such fluidly-connected at least one vacutainer, wherein the establishment of the fluid connection with the at least one vacutainer sealed at negative pressure causes at least some of the sample mixture from the sample container to be communicated to such fluidly-connected at least one vacutainer; and
(iv) a detection module in communication with the at least one vacutainer, and capable of detecting the presence of the target analytes.

2. The apparatus of claim 1, wherein at least one target analyte is a control, and the stabilized reagents include at least one of: (i) stabilized amplification reagents; and (ii) labeled probes associated with at least one of the target analytes; and the detection module is configured to detect the labelled probes associated with the one or more target analytes.

3. The apparatus of claim 1, wherein the at least one vacutainer is configured to encapsulate one or more reagents for target analyte identification, amplification, and/or detection.

4. The apparatus of claim 1, wherein an amount of the sample mixture is fluidly communicated from the sample container to the at least one vacutainer is based on one or more of (i) a volume of each such fluidly-connected vacutainers, and/or (ii) a magnitude of the negative pressure in each such fluidly-connected vacutainer when the fluid connection is established.

5. The apparatus of claim 1, wherein the engageable fluid communication channel is a non-boring, hollow needle.

6. The apparatus of claim 1, wherein the engageable fluid communication is configured to be established manually by pressing the sample container onto the engageable fluid communication channel, and the engageable fluid communication channel is configured to be disengaged, and the fluid connection disabled, by removing the manual pressure from the sample container when positioned on the needle.

7. The apparatus of claim 1, wherein the engageable fluid communication channel comprises a first end for communicating with the sample container, and at least one second end shaped to communicate with one or more vacutainers.

8. The apparatus of claim 1, wherein the engageable fluid communication channel comprises a first end configured to communicate with the sample container and a second, inverse-y-shaped end configured to communicate with two vacutainers.

9. The apparatus of claim 1, wherein the engageable fluid communication channel comprises a first end configured to communicate with the sample container and a second end having two or more subchannels or sub-ends configured to establish a fluid connection with the negative pressure in two or more of the vacutainers, wherein the first end is in fluid communication with each of the two or more second ends and/or subchannels.

10. The apparatus of claim 9, wherein the fluid communication channel is configured to engage the first end of the fluid communication channel with the sample container prior to engaging the at least one second end of the fluid communication channel with the negative pressure in any one of the at least one vacutainer.

11. The apparatus of claim 10, wherein the at least one second end of the fluid communication channel is configured such that each of the at least one second ends are sealed from atmospheric pressure or engaged with a vacutainer, when a first of such at least one second ends engages with a vacutainer.

12. The apparatus of claim 1, wherein the engageable fluid communication channel includes two or more second ends configured to fluidically communicate with two or more vacutainers, and if any one of the two or more second ends is connected to negative pressure in the two or more vacutainers, each of the other two or more second ends are either connected to negative pressure in another of the two or more vacutainers or are sealed.

13. A method for detecting at least one target analyte in a fluid sample comprises:
(i) acquiring the fluid sample;
(ii) combining the fluid sample in a sample container with at least one lysis reagent to create a sample mixture;
(iii) providing at least one vacutainer, each vacutainer sealed at a negative pressure with a sealing element, and containing stabilized reagents corresponding to detecting at least one of the target analytes;
(iv) engaging a fluid communication channel to create a fluid connection between the sample container and the at least one vacutainer through the sealing element of each fluidly-connected at least one vacutainer, wherein engagement of the fluid communication channel causes at least some of the sample mixture from the sample container to be communicated to such fluidly-connected at least one vacutainer; and
(v) determining a presence or absence of the at least one target analyte in the at least one vacutainer.

14. The method of claim 13, wherein the lysis reagent is lyophilized and/or is included within a sub-container within the at least one vacutainer.

15. The method of claim 13, wherein engaging a fluid communication channel in step (iv) comprises engaging a first end of the fluid communication channel with the sample container prior to engaging an at least one second end of the fluid communication channel with the negative pressure in any one of the at least one vacutainer.

16. The method of claim 15, further comprising providing a fluid communication channel configured to engage the first end of the fluid communication channel with the sample container prior to engaging the at least one second end of the fluid communication channel with the negative pressure in any one of the at least one vacutainer.

17. The method of claim 16, further comprising providing a fluid communication channel in which each of the at least one second ends are sealed from atmospheric pressure or engaged with a vacutainer, when a first of such at least one second ends engages with a vacutainer.

18. The method of claim 17, further comprising disengaging at least the first or the second end(s) of the fluid communication channel prior to determining the presence or absence of the at least one target analyte.

19. The method of claim 13, wherein the determining comprises providing an optical detection system to detect fluorescently labelled target analytes.

20. The method of claim 13, wherein the stabilized reagents include reagents capable of identifying, amplifying, and facilitating and/or allowing for detecting the target analytes.
